(19) United States
(12) Patent Application Publication
(10) Pub. No.: US 2007/0148288 A1
(43) Pub. Date: Jun. 28, 2007

(54) Long shelf-life Horchata beverage

(75) Inventors: Khalid M. Shammet, Tracy, CA (US); Meghan Meller, Sacramento, CA (US)

Correspondence Address: Robert Charles Hill, 235 Montgomery Street #821, San Francisco, CA, 94104, US

(73) Assignee: California Natural Products

(21) Appl. No.: 11/318,148

(22) Filed: Dec. 23, 2005

(51) Int. Cl. A23F 3/16

(52) U.S. Cl. 426/52

(57) ABSTRACT

A Horchata beverage manufacturing process mixes two distinct rice syrups, one from a high hydrolysis conversion and with a dextrose equivalence (DE) over 90%, and the other from a low hydrolysis conversion and with a DE under 20%. The mix is combined with water to form a slurry and heated. After homogenizing and cooling the slurry, aseptic packaging is used to prepare a Horchata beverage for sale that has a very long shelf-life and a very low cost-of-production.

### BACKGROUND OF THE INVENTION

1. Field of the Invention

The present invention relates to drinks and beverages, and more particularly to simplified methods and recipes for making Horchata, without dairy products or added sugars or preservatives, and for long shelf-life at ambient temperatures.

2. Description of Related Art

Horchata is a creamy refreshing cold drink traditionally made of rice, water, milk, and cinnamon. In some recipes, more flavors are added to the base, e.g., strawberry, banana, and chocolate. Some Horchata recipes include other major ingredients like almonds, regular milk, or condensed milk.

Horchata was an old-world drink brought to the New World by the Spanish in the Sixteenth Century. It was enjoyed by the Aztecs and other peoples of Mexico, Central America, and South America. In Old Spain, Horchata was made traditionally with ground melon seeds. In Latin America, the Spaniards substituted readily available squash seeds. Later, almonds and rice were incorporated into the drink after they were introduced in to the New World. Horchata drink is regarded as a perfect drink to accompany spicy Mexican foods. It is well known that drinking some milk or Horchata will quench the mouth burning.

Horchata is well suited for lactose intolerant individuals. Well over 50% of Hispanics, and even higher percentages of Asians, African Americans, and Native Americans, naturally become lactose intolerant after childhood. Horchata can often be used in place of milk as a beverage.

The usual Horchata drink has a short life span and needs to be refrigerated. Some recipes include milk, and many recipes do not cook the mix or use sterile ingredients or procedures. So bacteria will multiply quickly and spoil the drink in only a few days. Conventional methods also waste a lot of the starch, fiber, and protein coming off the rice. The insoluble debris precipitates to the bottom of the container, and is often filtered out. This waste adds to the overall cost and expense.

Table I illustrates a conventional recipe for making Horchata.

TABLE I

INGREDIENTS:
1 cup long grain rice, rinsed
2 quarts water
1 cinnamon stick, broken into pieces
1 teaspoon vanilla (optional)
½ cup white sugar
DIRECTIONS:
In a large saucepan, combine rice, water and cinnamon
stick. Set aside for 3 hours. Afterwards, bring to a
boil, reduce heat, and simmer for 30 minutes. Allow to
cool. Puree rice mixture in a blender until smooth.
Strain through cheesecloth or a fine sieve. Flavor with
vanilla and sugar to taste. Chill, and serve over ice.
Even though the drink has a milky appearance it is
completely dairy-free.

Table II is another recipe for making Horchata with milk.

TABLE II
Horchata - Ground Rice Drink
Yield: 6 servings

1 cups Long Grain Rice
4 cups Milk
½ cups Sugar 1 teaspoon Vanilla
½ teaspoon Cinnamon
Ice
Place the rice in a bowl with enough hot water to
cover. Let the rice sit overnight. Next day, remove
the water. Place ½ cup of water, and 2 cups milk in a
blender. Blend until rice is all ground up. Mix in ¼
cup sugar, ½ t vanilla, ¼ t cinnamon. Do the same
with the other half of the ingredients. Strain through
cheesecloth (or whatever). Serve over ice. Makes 6
glasses.

Making Horchata with conventional methods can be very time consuming, e.g., soaking rice over night, grinding, filtering, etc. More than half the rice used will be wasted, most of the larger size, fiber, protein and all insoluble material will precipitate to the bottom of the container. The usual Horchata drink shelf-life is very short, and the typical product should be refrigerated.

What is needed is a method for making Horchata that is efficient and produces a good tasting. drink with a long shelf-life.

### SUMMARY OF THE INVENTION

Briefly, a Horchata beverage manufacturing embodiment of the present invention comprises blending a final Horchata drink from a high dextrose equivalent (DE) rice base, and a low DE rice base. Each are obtained from parallel separate hydrolyses of rice starches with different glucose/maltose and oligosaccharide ratios. The low DE rice. base includes a rice oligodextrin which provides the body and rice flavor. The high DE rice base is a syrup that provides sweetness. Both are made enzymatically from organic, polished, brown, or white rice.

An advantage of the present invention is a Horchata manufacturing method is provided for continuous production of high quality Horchata drink, with no waste using enzymatic processes.

Another advantage of the present invention is a Horchata manufacturing method is provided that uses enzymatic processes to reduce waste.

A further advantage of the present invention is a Horchata manufacturing method is provided to produce a Horchata drink without needing sugar, whiteners, preservatives, condensed milk, sweetened milk, or other dairy products.

A still further advantage of the present invention is a Horchata manufacturing method is provided with aseptic processing methods that improve its room-temperature shelf-life over conventional products.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a flowchart diagram of a Horchata beverage manufacturing method embodiment of the present invention;

FIG. 2 is a flowchart diagram of a way to make the high-DE rice base used in the process of FIG. 1;

FIG. 3 is a flowchart diagram of a way to make the low-DE rice base used in the process of FIG. 1; and

FIG. 4 is a flowchart diagram of a Horchata beverage aseptic process embodiment of the present invention.

### DETAILED DESCRIPTION OF THE INVENTION

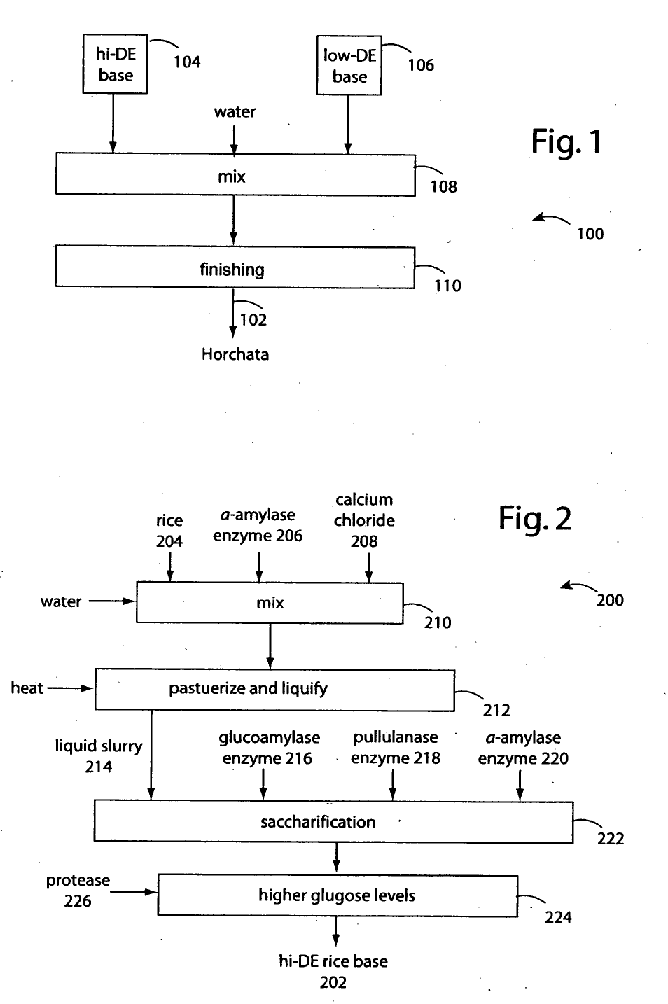

FIG. 1 represents a Horchata beverage manufacturing method embodiment of the present invention, and is referred to herein by the general reference numeral 100. The Horchata beverage manufacturing method 100 comprises blending a final Horchata drink 102 from a high dextrose equivalent (DE) rice base 104, and a low DE rice base 106. Both bases 104 and 106 are made enzymatically from organic, polished, brown, or white rice. Each of the bases are obtained from parallel separate hydrolyses of rice starches for different glucose/maltose and oligosaccharide ratios. The low DE rice base 106 includes a rice oligodextrin which provides body and a rice flavor. The high DE rice base 104 is a syrup that provides sweetness. The two are balanced with water in a step 108 to provide the desired taste, appearance, and body. A finishing step 110 can include thermal processing, pasteurizing, homogenization, and aseptic packing. Such step 110 also adds natural flavors, natural oils, and emulsifier salts like monosodium, disodium and trisodium phosphate.

Table III lists the range of ingredient mixtures possible in one instance of the Horchata drink 102.

TABLE III

| Ingredient | Usage Range (%) |
|---|---|
| Rice Oligodextrin A | 10-90 |
| Rice Dextrins B | 10-90 |
| Filtered water | 10-40 |
| Flavors | 0-5.0 |
| Safflower Oil | 0-5.0 |
| Disodium Phosphate (anhydrous) | 0-1.0 |

As an example of a rice syrup sweetener made from whole grain rice, Mitchell, et al., describe in U.S. Pat. No. 4,876,096, issued Oct. 24, 1989. Either white or brown rice is liquefied in a saccharification step with glycosidase and/or beta-amylase enzyme. The enzymatic reaction time is limited to about four hours for both liquefaction and saccharification steps to avoid undesirable off-flavors. The saccharification product is clarified to remove substantially all the rice fiber, and concentrated to produce a rice syrup sweetener, as in Table IV. Such syrup can be dried to produce dried rice sweeteners.

TABLE IV

| | | |
|---|---|---|
| Soluble Complex Carbohydrates | 10-70% | of solids |
| Maltose | 0-70% | of solids |
| Glucose | 5-70% | of solids |
| Ash or Minerals | 0.1-0.6% | of solids |
| Protein and Fat | 1-3.5% | of solids |

FIG. 2 represents a way to make the high-DE rice base 104. A rice syrup method embodiment of the present invention, referred to herein by the general reference numeral 200 provides a rice base 202 with a DE over 90%. Using a high-DE rice syrup to sweeten the Horchata 102 eliminates the need to use refined sugar or high fructose corn syrup. In method 200, over 90% of the rice carbohydrates are converted to glucose using enzymes. A feed of rice grain particles 204, a high temperature a-amylase enzyme 206, and calcium chloride 208 are mixed with water in a step 210. A liquefaction step 212 uses heat and the amylases to liquefy the rice grain particles. A resulting liquid slurry 214 is treated with glucoamylase protease 216 to hydrolyze the protein, a pullulanase 218 is used as a de-branching enzyme, and a-amylase 220 is added to reduce the slurry viscosity, all in a saccharification step 222.

Such saccharification step 222 takes 30-80 minutes. But, higher glucose levels can be obtained in a step 224 by treating the slurry 214 even further with glucoamylase and pullulanase for up to twelve hours.

The pullulanase 218 is included to reduce the levels of glucoamylase 216 needed during saccharification, and it improves the ultimate glucose yield. A protease 226 is added to hydrolyze proteins and reduce foaming.

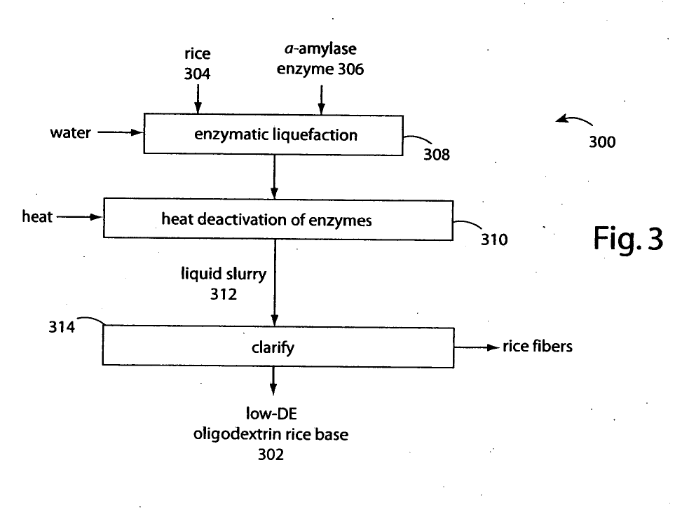

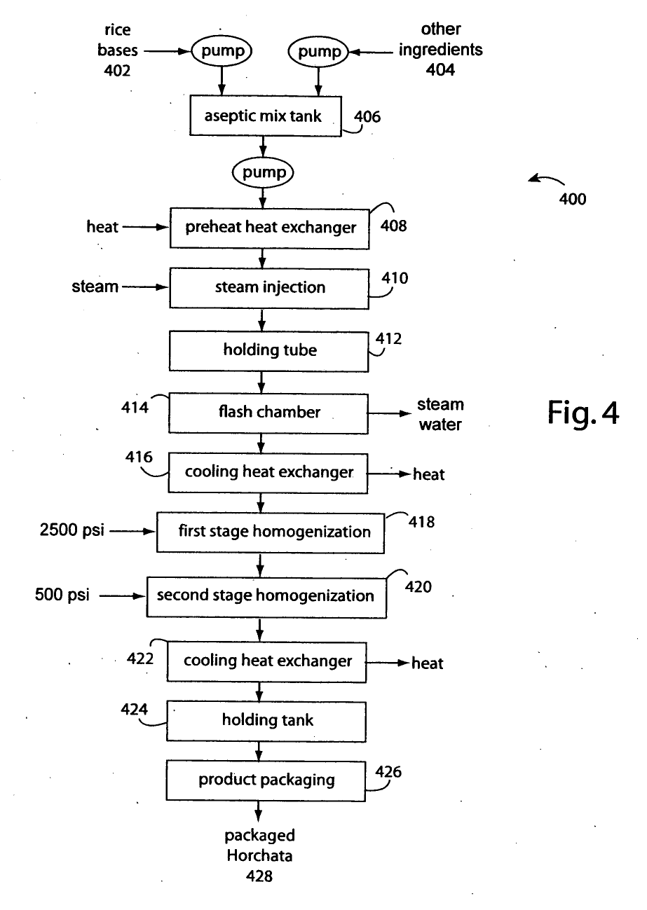

FIG. 3 represents a process to make the low-DE rice base 106, of FIG. 1. A method embodiment of the present invention, referred to herein by the general reference numeral 300 provides a rice base 302 with a DE under 20%. The low-DE rice base 106, FIG. 1, is a white-color oligodextrin from a low-enzyme conversion process like method 300. It is a viscous fluid with a rice flavor and provides body to the Horchata. An input of white rice 304 is used to make a rice oligodextrin by enzymatically converting its starches with a-amylase enzymes 306 in a liquefaction process 308. The enzymes are deactivated with heat in a step 310. Then a slurry 312 from the liquefaction step is clarified in a step 314 to remove substantially all the rice fiber. The rice base 302 is placed on holding tank for further processing, e.g., as in FIG. 4. The resulting product is bland with a hint of rice flavor and is not so sweet since the DE is less than 20%.

A suitable rice base 302 may be commercially available. California Natural Products (Lathrop, Calif.) manufactures rice oligodextrin solids in a variety of DE's, without using acid, alkali or sulfite. They are bland in taste and disperse readily in aqueous solutions. Rice oligodextrins are used for many of the same applications as maltodextrins, including viscosity and body modification of liquid systems, flavor carriers, hypoallergenic products, oral dehydration and sports beverages or carbohydrate loading products, control of osmolality, and as a bulking agent. “Maltodextrin” must contain a maximum of 0.5% protein. CNP's oligodextrins contain about 3% protein, so they cannot be called maltodextrin, although they do have similar DE and functionality. Products are currently available in DE's of 5, 10, and 18.

FIG. 4 represents a Horchata beverage aseptic process embodiment of the present invention, and is referred to herein by the general reference numeral 400. The aseptic process 400 provides a Horchata beverage with an extended shelf life at room temperature, e.g., 9-12 months. The aseptic process begins by pumping rice base ingredients 402 and other ingredients 404 into an aseptic mix tank 406. The rice base ingredients 402 include two distinct rice syrups, one from a high hydrolysis conversion and with a DE over 90%, and the other from a low hydrolysis conversion and with a DE under 20%. The other ingredients 404 include spices, oils, and flavors.

Once thoroughly mixed with water, a slurry is pumped to a heat exchanger 408. The heat exchanger preheats the product to 170-180° F., and can be either a tubular heat exchanger or a plate heat exchanger. The product is then steam injected to obtain a temperature of at least 284° F. in an injector 410. The temperature is held in a holding tube 412, then the water from the steam injection is removed in a flash chamber 414. The product is cooled to 180-190° F. in another heat exchanger 416 before being homogenized in two stages, e.g., a first homogenizer 418 set to 2500 psi, and a second stage homogenizer 420 set to 500 psi. Once the Horchata is homogenized, it passes though another heat exchanger 422 to cool the product to 85-90° F. The product is then pumped to a holding tank 424, e.g., a Steri-tank, until it is ready to be packaged in step 426. The fill temperature for a packaged Horchata-type beverage 428 is around 80° F.

Embodiments of the present invention to manufacture Horchata combine two rice-based ingredients, one high DE and one low DE, along with natural flavors, natural oil, emulsifier salts like sodium phosphate. The formulation provides a clean, all-natural, non-dairy ingredient declaration. Such Horchata drink does not need preservatives, artificial flavors, or artificial colors. It can be described as a refreshing, creamy, white beverage with different types of flavors that include cinnamon, vanilla, rice, banana, strawberry, chocolate, etc.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A method for making a beverage, comprising:
converting a first input of rice to a oligodextrin base with a dextrose equivalent (DE) of less than 20%;
hydrolyzing a second input of rice to a dextrin syrup base with a dextrose equivalent (DE) of more than 90%; and
mixing in a particular ratio said oligodextrin base, to provide body and rice flavor, with said dextrin syrup base, to provide sweetness.

2. The method of claim 1, wherein:
the converting uses enzymatic liquefaction with a-amylase followed by heat deactivation.

3. The method of claim 1, wherein:
the hydrolyzing includes mixing said rice with a-amylase and calcium chloride in a liquid slurry and heating.

4. The method of claim 1, wherein:
the hydrolyzing is followed by a saccharification process to increase glucose levels.

5. The method of claim 1, further comprising:
saccharification with glucoamylase and pullulanase enzymes after hydrolyzing to increase glucose levels.

6. A beverage manufacturing process, comprising:
pumping into an aseptic mix tank ingredients including two distinct rice syrups, one from a high hydrolysis conversion and with a DE over 90%, and the other from a low hydrolysis conversion and with a DE under 20% and thoroughly mixing with water to form a slurry;
heating said slurry to a first temperature for a predetermined time;
cooling said slurry to a predetermined temperature;
homogenizing said slurry; and
aseptic packaging a beverage resulting from the homogenizing.

7. The process of claim 6, wherein:
the heating includes first preheating said slurry to 170-180° F., then steam injecting said slurry to obtain a temperature of at least 284° F., then holding the temperature in a holding tube, and then removing the water from steam injection in a flash chamber.

8. The process of claim 6, wherein:
the cooling reduces the temperature of said slurry to about 180-190° F. in a heat exchanger.

9. The process of claim 6, wherein:
the homogenizing is in two stages with a first homogenizer set to about 2500 psi, and a second stage homogenizer set to about 500 psi.

10. The process of claim 6, further comprising:
after homogenizing, passing said slurry though a heat exchanger to cool the product to about 85-90° F.; and
pumping to a holding tank until it is ready to be packaged and using a fill temperature around 8020 F.;
wherein a packaged Horchata-type beverage is prepared.

11. A Horchata-type beverage manufacturing process, comprising:
pumping into an aseptic mix tank ingredients including two distinct rice syrups, one from a high hydrolysis conversion and with a DE over 90%, and the other from a low hydrolysis conversion and with a DE under 20% and thoroughly mixing with water to form a slurry;
heating which includes first preheating said slurry to 170-180° F., then steam injecting said slurry to obtain a temperature of at least 284° F., then holding the temperature in a holding tube, and then removing the water from steam injection is in a flash chamber;
cooling to reduce the temperature of said slurry to 180-190° F. in a heat exchanger;
homogenizing in two stages with a first homogenizer set to about 2500 psi, and a second stage homogenizer set to about 500 psi;
passing said slurry though a heat exchanger to cool the product to about 85-90° F.;
sending to a holding tank until it is ready to be packaged and using a fill temperature around 80° F.; and
aseptic packaging a beverage from the homogenizing;
wherein, a packaged Horchata-type beverage is prepared.
